(19) United States
(12) Patent Application Publication
(10) Pub. No.: US 2011/0000090 A1
(43) Pub. Date: Jan. 6, 2011

(54) DEVICE FOR CRACKING HARD OBJECTS

(75) Inventor: KIT KWAN PAU, Hong Kong (HK)

Correspondence Address: J C PATENTS, 4 VENTURE, SUITE 250, IRVINE, CA, 92618, US

(73) Assignee: WINGS PRODUCT WORKSHOP LIMITED, Hong Kong (HK)

(21) Appl. No.: 12/497,381

(22) Filed: Jul. 2, 2009

(51) Int. Cl. A47J 43/26

(52) U.S. Cl. 30/120.2

(57) ABSTRACT

A device for cracking hard objects is provided, which comprising a base component; an actuating component movable with respect to the base component; a jaw attached to one of the base component and the actuating component in such a manner the jaw is displaceable with respect to said one of the base component and the actuating component, which cracks the hard objects to be cracked with the other one of the base component and the actuating component; a dampening means provided between the jaw and said one of the base component and the actuating component and tending to push the jaw away from said one of the base component and the actuating component. With the device for cracking hard objects according to the present invention, an excessive force applied on the objects could be reduced or absorbed, thus, the force could be applied on the objects in a controllable manner.

### FIELD OF THE INVENTION

The present invention relates to the field of a device for cracking hard objects.

### BACKGROUND OF THE INVENTION

Some kinds of nuts, such as cashews, walnuts, almonds, etc, have hard shells. As it is difficult to break the hard shells by hand, nut crackers have been developed and used for this matter for many years. However, the force applied on the shells of nuts by conventional nut crackers is not controllable. If the force is excessively large, the shells would be crushed and the fragments of the shells might insert in the kernel of the nuts, or even the kernel is also crushed. The thus obtained kernel would be in a mess and not suitable for eating.

In addition, as the conventional nut crackers generally could not constrain the fragments of the shells, some fragments might shoot out during the cracking of the shells if an excessive force is exerted thereon, which might incur property damage or even personal injury.

Similarly, to crack the shells of lobsters, crabs or other hard objects, some similar crackers could be used. However, the problems as mentioned above would also be encountered.

### SUMMARY OF THE INVENTION

The present invention mainly aims to provide a device for cracking hard objects to overcome the above drawbacks.

The goal of the present invention is achieved by means of a device for cracking hard objects, which may comprise a base component; an actuating component movable with respect to the base component; a jaw attached to one of the base component and the actuating component in such a manner the jaw is displaceable with respect to said one of the base component and the actuating component, which cracks the hard objects to be cracked with the other one of the base component and the actuating component; a dampening means provided between the jaw and said one of the base component and the actuating component and tending to push the jaw away from said one of the base component and the actuating component.

In one aspect, the base component and the actuating component may be a pair of arms, one of the arms includes an outer surface, an inner surface and a receiving groove recessed into the inner surface, and the jaw is received in the receiving groove.

Preferably, the jaw may include a projection extended from one end of the jaw along the length thereof, a tab extended from the opposite end of the jaw and an elongated aperture formed within the tab; and said one of the arms includes an elongated slot formed at one side of the receiving groove to receive the projection of the respective jaw and a gap formed at the opposite side of the receiving groove to receive the tab of the respective jaw, in which the tab is located within the gap by passing a fixing pin through the elongated aperture, the length of the elongated slot is relatively larger than the size of the projection to enable the projection to move slightly along the elongated slot, and the length of the elongated aperture is relatively larger than the size of the fixing pin to enable the tab to move slightly along the depth of the gap.

In addition, the jaw may include a plurality of teeth formed on a surface thereof opposite to said one of arms, and the toothed surface of the jaw is of a concave shape and each of the teeth forms a concave contour at a tip thereof.

As an extension of the teeth of the jaw, a plurality of teeth may be formed on the inner surface of said one of the arms beside one or both sides of the receiving groove.

Furthermore, the other one of the arms includes an outer surface and an inner surface, and a plurality of teeth are formed on the inner surface facing to the jaw. The toothed surface of said other one of the arms is of a concave shape and each of the teeth forms a concave contour at a tip thereof.

The pair of arms are pivotally connected to each other, or the pair of arms are integrated with each other at one end to form a single piece.

In another aspect, the base component is a frame with a screw hole formed through a top end thereof, and the actuating component is an actuating rod with a thread formed on outer surface thereof; through the screw hole, an upper end of the actuating rod extends outside of the frame with the thread of the actuating rod engaging with the thread in the screw hole; and the jaw is attached to one of the frame and actuating rod, and the dampening means is provided between the jaw and said one of the frame and the actuating rod and tends to push the jaw away from said one of the frame and the actuating rod.

Particularly, the frame forms a closed configuration with an opening on a side thereof to access the hard objects to be cracked. An inner surface of bottom of the frame is of a concave shape with a plurality of ribs radially formed thereon, while a surface of the jaw facing to the other one of the frame and the actuating rod is of a concave shape with a plurality of ribs radially formed thereon.

In still another aspect, the device may comprise two jaws each of which is attached to the base component and the actuating component respectively, and two dampening means each of which is provided between one of the jaws and the base component and between the other jaw and the actuating component respectively.

The dampening means are comprised of elastic material, such as, rubber or silicone, etc.

With the device for cracking hard objects of the present invention, the force could be applied on the objects in a controllable manner, thus, the objects would be cracked normally and would not be crushed in a mess. In addition, with the concave configuration of the jaws and the teeth thereof, the fragments of the objects could be constrained within the “cradle” formed by the jaws and teeth and be prevented from shooting out during the cracking.

### BRIEF DESCRIPTION OF THE DRAWINGS

The embodiments of the present invention will be described in detail with reference to the accompanying drawings. The figures are for illustration purposes only and are not drawn to scale, in which,

FIG. 1 is a side view of the device for cracking hard objects according to a first embodiment of the present invention in the closed position;

FIG. 2 is a cross section view of the device for cracking hard objects of FIG. 1 taken along the section A-A;

FIG. 3 is an exploded perspective view of an arm of the device for cracking hard objects of FIG. 1;

FIG. 4 is an exploded side view of the arm of FIG. 3;

FIG. 5 is a schematic view of the operation of the device for cracking hard objects of FIG. 1;

FIG. 6 is a side view of the device for cracking hard objects according to a second embodiment of the present invention in the closed position;

FIG. 7 is a perspective view of the device for cracking hard objects according to a third embodiment of the present invention;

FIG. 8 is a front view of the device for cracking hard objects of FIG. 7; and

FIG. 9 is a cross section view of the device for cracking hard objects of FIG. 7 taken along the section of I-I.

### DETAILED DESCRIPTION OF THE INVENTION

Reference will now be made in detail to the preferred embodiments of the invention, which is illustrated in the accompanying figures, in which similar parts or elements are identified by like reference numerals.

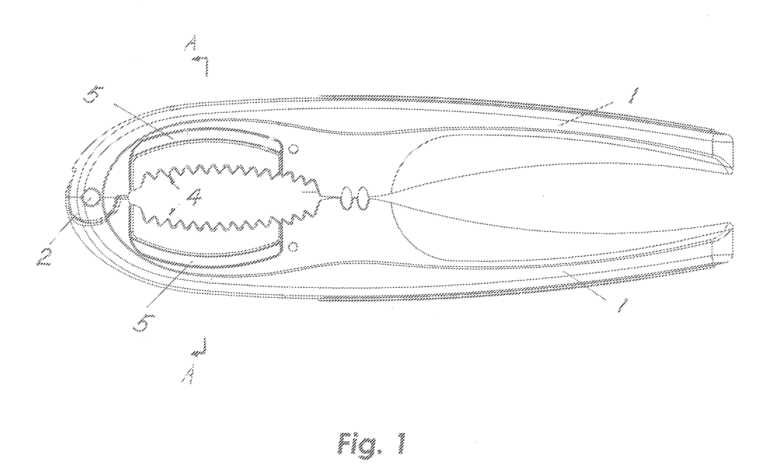

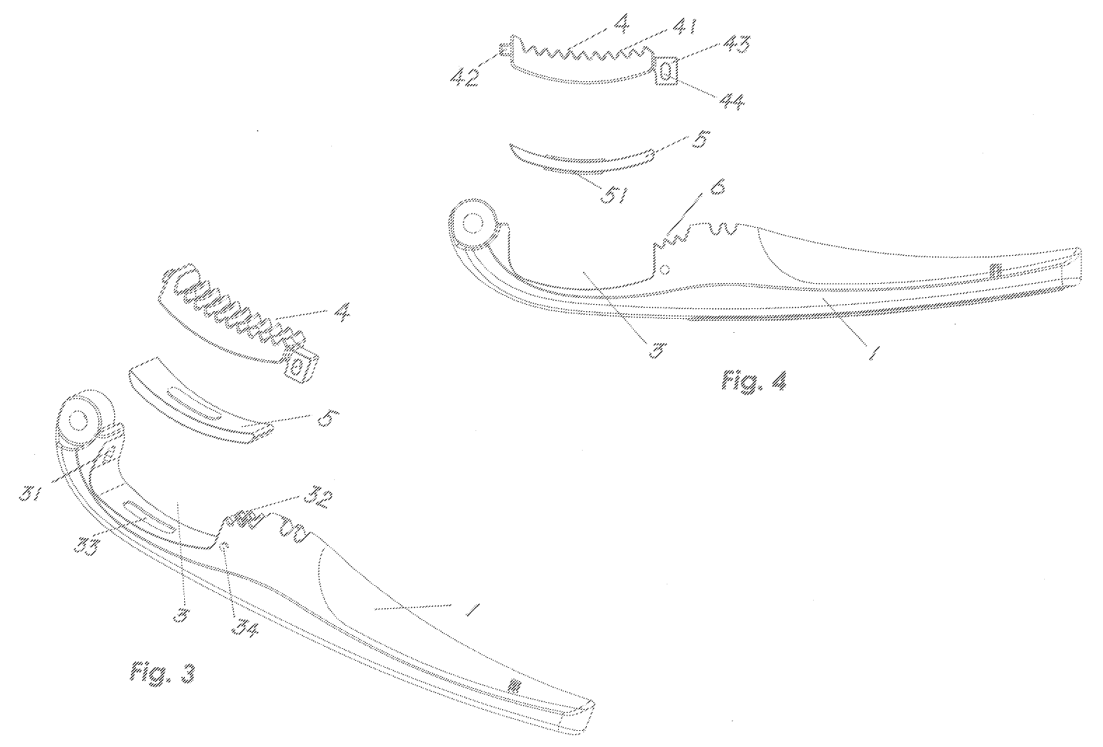

As shown in FIG. 1, the device for cracking hard objects of the first embodiment of the present invention comprises a pair of arms 1 pivotally connected to each other at one end about a pin 2. However, although not shown in the figures, the arms of the device could be pivotally connected to each other at the middle part of the arms. Each of the arms 1 has an inner surface, an outer surface and a receiving groove 3 (see FIG. 3) recessed into the inner surface. The receiving grooves 3 may be formed near the connected end of the arms and each contains a jaw 4 for contacting an object 7 to be cracked (see FIG. 5). Between each set of the arm 1 and jaw 4 a dampening means 5 is provided within each of the receiving grooves 3.

As shown in FIGS. 3 and 4, each jaw 4 includes a plurality of teeth 41 formed on a surface thereof opposite to the respective arm 1 to which the jaw is attached, a projection 42 extended from one end of the jaw 4 along the length thereof, and a tab 43 extended from the opposite end. An elongated aperture 44 is formed within the tab 43. Correspondingly, to receive the projection 42 of the jaw 4, an elongated slot 31 is formed in the arm 1 at one side of the receiving groove 3 facing to the projection 42. The length of the elongated slot 31 is relatively larger than the size of the projection 42, to enable the projection 42 to move slightly along the elongated slot 31. Besides, to receive the tab 43 of the jaw 4, a gap 32 is formed in the arm 1 at the opposite side of the receiving groove 3. The tab 43 could be located within the gap 32 by passing a fixing pin 34 through the elongated aperture 44 across the gap 32. Similarly, the length of the elongated aperture 44 is relatively larger than the size of the fixing pin 34 to enable the tab 43 to move slightly along the depth of the gap 32. Therefore, the jaw 4 as a whole could move back and forth relative to the arm 1, and each dampening means 5 tends to push the respective jaw 4 away from the respective arm 1.

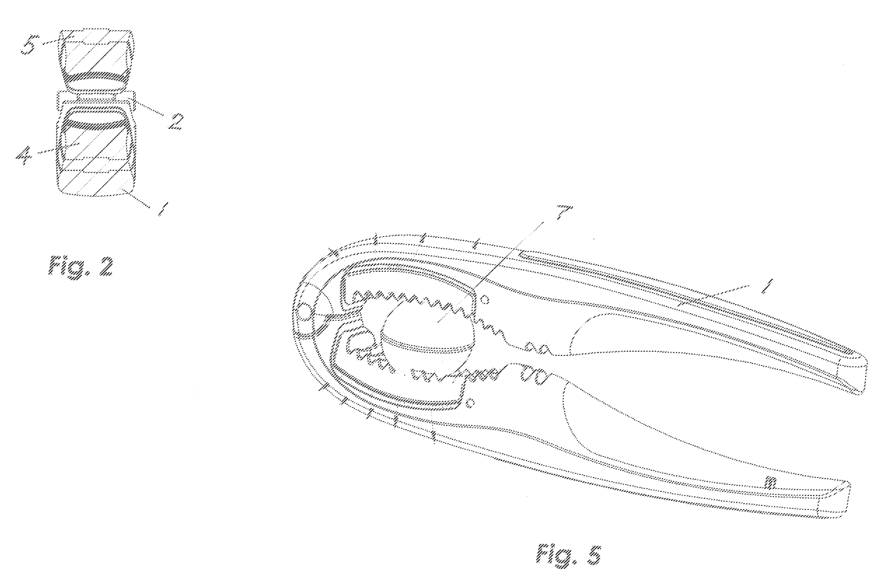

The arms 1 and the jaws 4 may be comprised of hard material, such as metal, rigid plastics, and so on, while the dampening means 5 may be made of elastic material, such as polymer. The polymer may be elastomer or plastics, such as rubber or silicone, etc. For example, to attach the dampening means 5 to the arm 1, a protrusion 51 may be formed on a surface of the dampening means 5 facing to the respective arm 1, and a corresponding recess 33 may be formed in the respective arm 1 within the receiving groove 3, thus the protrusion 51 could be fitted into the recess 33. Besides, an additional protrusion could be formed on a surface of the dampening means 5 facing to the respective jaw 4, and a corresponding recess (see FIG. 2) could be formed in the bottom of that jaw 4, thus the additional protrusion could be fitted into the recess in the jaw, to enhance the stability of the dampening means 5.

As shown in FIG. 5, in order to operate the device of the present invention, the arms 1 are opened, and the jaws 4 would also be moved apart together with their respective arms. Then, the hard object 7 to be cracked, such as nut, lobster, crab or other object with hard shell, is placed between the jaws 4. Subsequently, the user could exert force on the arms 1 to crack the object 7, and thus the teeth 41 of the jaws 4 start to contact the object 7 and the force is transmitted thereto. Then, the force applied on the object 7 would deform the dampening means 5 to certain extent according to the amount of the force. With the compression of the dampening means 5 in the direction indicated by the arrows in FIG. 5, the jaws 4 would move towards their respective arms 1. Thus, the excessive force applied on the object 7 would be reduced or absorbed with the movement of the jaws 4, and then a suitable force would be applied on the object 7. Thus, the force could be applied on the object to be cracked in a controllable manner. After the object 7 is cracked, the resilience of the dampening means 5 would smoothly push the respective jaws 4 away from the respective arms 1 to their initial positions.

Preferably, the toothed surface of each jaw 4 could be of a concave shape along the length of the jaw, as shown in FIGS. 1 and 4. In addition, each tooth on the jaw 4 may also form a concave contour at the tip thereof, as shown in FIG. 2. Therefore, during a hard object is cracked, the fragments of the object could be constrained within a “cradle” formed by the jaws, to prevent the fragments from shooting out.

Preferably, as an extension of the teeth 41 of the jaws 4, a plurality of teeth 6 could be formed on the inner surface of each arm 1 beside one or both sides of the receiving grooves 3.

Alternatively, although not shown in the figures, only one of the arms 1 is provided with a jaw 4 and a dampening means 5 within the receiving groove 3 thereof, while the other arm is not provided with the receiving groove, the jaw and the dampening means. Preferably, the inner surface of the arm without receiving groove may be of a concave shape at the portion facing to the jaw 4. Similarly, a plurality of teeth could be formed at the above-mentioned portion to face to the teeth formed on the jaw 4.

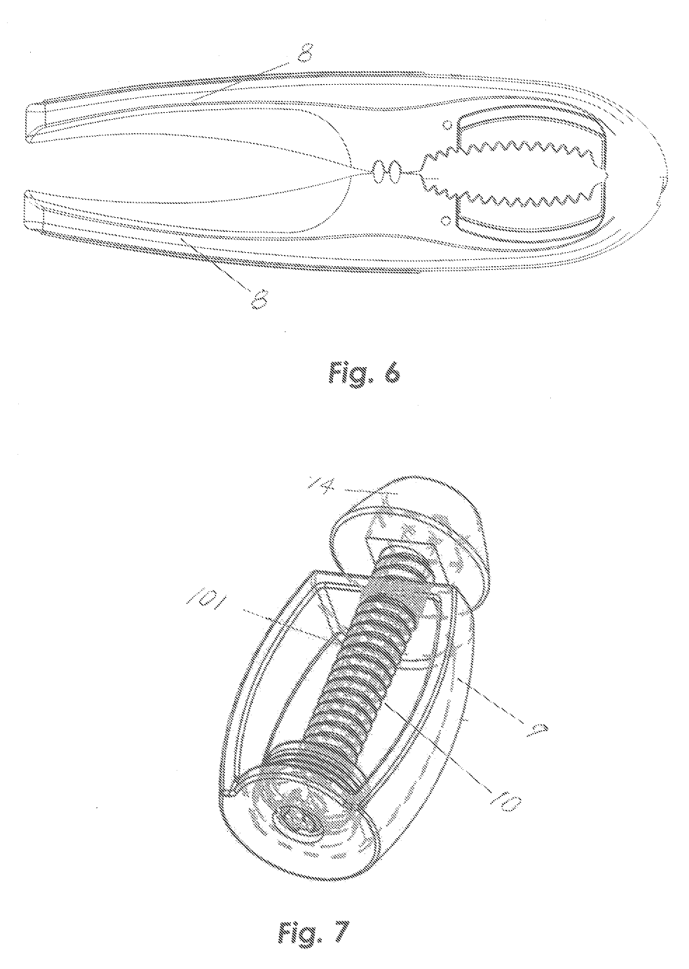

The second embodiment of the device for cracking hard objects of the present invention is shown in FIG. 6. Comparing to the first embodiment, the pair of arms 8 in the second embodiment are integrated with each other at one end to form a single piece. Except for the above difference, the other components and the operation of the second embodiment of the present invention are the same as those of the first embodiment, the details of which would not be repeated here.

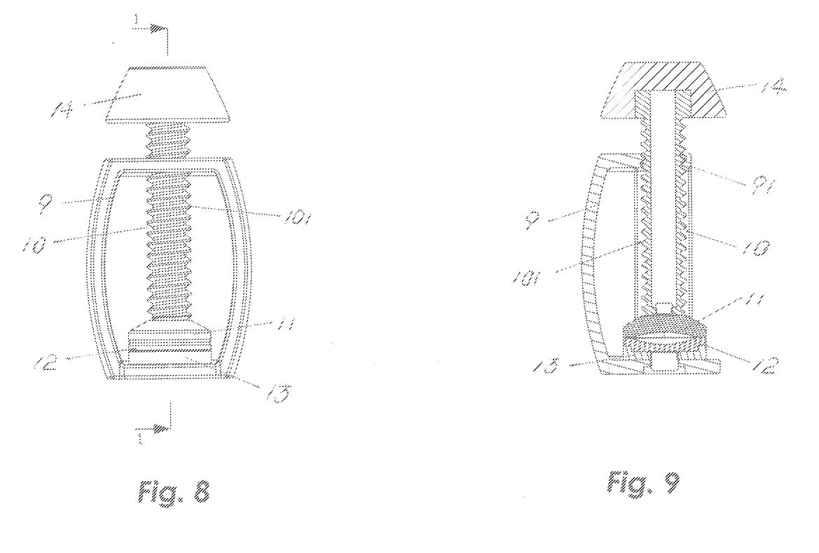

FIGS. 7-9 show the third embodiment of the device for cracking hard objects of the present invention. As shown in FIG. 7, the third embodiment comprises a frame 9 with a screw hole 91 (see FIG. 9) formed through the top end thereof, and an actuating rod 10 with a thread 101 formed on outer surface thereof. Through the screw hole 91, an upper end of the actuating rod 10 extends outside of the frame 9, with the thread 101 engaging with the thread in the screw hole 91. A flange 11 is formed at the lower end of the actuating rod 10. A jaw 13 is attached to the flange 11 from the lower side of the latter in such a matter that the jaw 13 is displaceable with respect to the flange 11 along the longitudinal axis of the actuating rod 10. A dampening means 12 is provided between the flange 11 and the jaw 13 to tend to push the jaw 13 away from the flange 11. A handle 14 could be provided at the upper end of the actuating rod 10, to enable to rotate to the actuating rod 10 with respect to the frame 9 easily.

The frame 9, the actuating rod 10 and the jaw 13 may be comprised of hard material, such as metal, rigid plastics, and so on, while the dampening means 12 may be made of elastic material, such as polymer. The polymer may be elastomer or plastics, such as rubber or silicone etc.

The frame 9 may be of any suitable shape, such as a drum, a cylinder, a cuboid and so on. To constrain the fragments of the objects from shooting out, the frame 9 may preferably form a closed configuration with an opening on a side thereof to access the object to be cracked. Preferably, the inner surface of the bottom of the frame 9 on which the object is to be deposited may be of a concave shape. More preferably, a plurality of ribs (not shown in the figures) may be radially formed on the inner surface of the bottom of the frame 9. Similarly, the lower surface of the jaw 13 facing to the bottom of the frame 9 may be of a concave shape, and a plurality of ribs may be radially formed on the lower surface.

To operate the third embodiment, the actuating rod 10 is first rotated in a direction to raise the jaw 13 attached to the flange 11 of the actuating rod. Then, the object to be cracked is deposited on the inner surface of the bottom of the frame 9 facing to the jaw 13. Subsequently, the actuating rod 10 is rotated in the opposite direction to lower the jaw 13, thus the force is applied on the object to be cracked once upon the contact between the jaw 13 and the object. The force applied on the object would deform the dampening means 12 to certain extent according to the amount of the force. With the jaw 13 lowered continuously, the dampening means 12 is compressed continuously, and the jaw 13 would move towards the flange 11. Thus, the excessive force applied on the object would be reduced or absorbed with the movement of the jaw 13, and then a suitable force would be applied on the object. Thus, the force could be applied on the object to be cracked in a controllable manner. After the object is cracked, the resilience of the dampening means 12 would smoothly push the jaw 13 away from the flange 11 to its initial position.

Although not shown in the figures, the jaw 13 could be positioned on the inner surface of the bottom of the frame 9, and the dampening means 12 may be provided between the jaw 13 and the inner surface. Or, a set of jaw and dampening means could be provided with the frame 9 and the actuating rod 10 respectively.

Although the description of the present invention is made with reference to the preferred embodiments, the present invention is not limited to these embodiments. Various modifications and changes can be made to the invention by those skilled in the art without departing from the spirit and scopes of the present invention.

What is claimed is:

1. A device for cracking hard objects comprising:
a base component;
an actuating component movable with respect to the base component;
a jaw attached to one of the base component and the actuating component in such a manner the jaw is displaceable with respect to said one of the base component and the actuating component, which cracks the hard objects to be cracked with the other one of the base component and the actuating component;
a dampening means provided between the jaw and said one of the base component and the actuating component and tending to push the jaw away from said one of the base component and the actuating component.

2. The device for cracking hard objects according to claim 1, wherein the base component and the actuating component are a pair of arms, one of the arms includes an outer surface, an inner surface and a receiving groove recessed into the inner surface, and the jaw is received in the receiving groove.

3. The device for cracking hard objects according to claim 2, wherein the jaw includes a projection extended from one end of the jaw along the length thereof, a tab extended from the opposite end of the jaw and an elongated aperture formed within the tab; and said one of the arms includes an elongated slot formed at one side of the receiving groove to receive the projection of the respective jaw and a gap formed at the opposite side of the receiving groove to receive the tab of the respective jaw, in which the tab is located within the gap by passing a fixing pin through the elongated aperture, the length of the elongated slot is relatively larger than the size of the projection to enable the projection to move slightly along the elongated slot, and the length of the elongated aperture is relatively larger than the size of the fixing pin to enable the tab to move slightly along the depth of the gap.

4. The device for cracking hard objects according to claim 3, wherein the jaw includes a plurality of teeth formed on a surface thereof opposite to said one of arms.

5. The device for cracking hard objects according to claim 4, wherein the toothed surface of the jaw is of a concave shape and each of the teeth forms a concave contour at a tip thereof.

6. The device for cracking hard objects according to claim 2, wherein a plurality of teeth are formed on the inner surface of said one of the arms beside one or both sides of the receiving groove.

7. The device for cracking hard objects according to claim 2, wherein the dampening means are comprised of elastic material.

8. The device for cracking hard objects according to claim 7, wherein the dampening means are comprised of rubber or silicone.

9. The device for cracking hard objects according to claim 2, wherein the other one of the arms includes an outer surface and an inner surface, and a plurality of teeth are formed on the inner surface facing to the jaw.

10. The device for cracking hard objects according to claim 9, wherein the toothed surface of said other one of the arms is of a concave shape and each of the teeth forms a concave contour at a tip thereof.

11. The device for cracking hard objects according to claim 2, wherein the pair of arms are pivotally connected to each other.

12. The device for cracking hard objects according to claim 2, wherein the pair of arms are integrated with each other at one end to form a single piece.

13. The device for cracking hard objects according to claim 1, wherein
the base component is a frame with a screw hole formed through a top end thereof, and the actuating component is an actuating rod with a thread formed on outer surface thereof;
through the screw hole, an upper end of the actuating rod extends outside of the frame with the thread of the actuating rod engaging with the thread in the screw hole; and
the jaw is attached to one of the frame and actuating rod, and the dampening means is provided between the jaw and said one of the frame and the actuating rod and tends to push the jaw away from said one of the frame and the actuating rod.

14. The device for cracking hard objects according to claim 13, wherein the frame forms a closed configuration with an opening on a side thereof to access the hard objects to be cracked.

15. The device for cracking hard objects according to claim 13, wherein an inner surface of bottom of the frame is of a concave shape with a plurality of ribs radially formed thereon.

16. The device for cracking hard objects according to claim 13, wherein a surface of the jaw facing to the other one of the frame and the actuating rod is of a concave shape with a plurality of ribs radially formed thereon.

17. The device for cracking hard objects according to claim 13, wherein the dampening means are comprised of elastic material.

18. The device for cracking hard objects according to claim 17, wherein the dampening means are comprised of rubber or silicone.

19. The device for cracking hard objects according to claim 1, wherein the device comprises two jaws each of which is attached to the base component and the actuating component respectively, and two dampening means each of which is provided between one of the jaws and the base component and between the other jaw and the actuating component respectively.

20. The device for cracking hard objects according to claim 19, wherein the base component and the actuating component are a pair of arms, each of the arms includes an outer surface, an inner surface and a receiving groove recessed into the inner surface, and each of the jaws is received in each of the receiving grooves.

21. The device for cracking hard objects according to claim 20, wherein each of the jaws includes a projection extended from one end of the jaw along the length thereof, a tab extended from the opposite end of the jaw and an elongated aperture formed within the tab; and each of the arms includes an elongated slot formed at one side of the receiving groove to receive the projection of the respective jaw and a gap formed at the opposite side of the receiving groove to receive the tab of the respective jaw, in which the tab is located within the gap by passing a fixing pin through the elongated aperture, the length of the elongated slot is relatively larger than the size of the projection to enable the projection to move slightly along the elongated slot, and the length of the elongated aperture is relatively larger than the size of the fixing pin to enable the tab to move slightly along the depth of the gap.

22. The device for cracking hard objects according to claim 21, wherein each of the jaws includes a plurality of teeth formed on a surface thereof opposite to the respective arm.

23. The device for cracking hard objects according to claim 22, wherein the toothed surface of each of the jaws is of a concave shape and each of the teeth forms a concave contour at a tip thereof.

24. The device for cracking hard objects according to claim 20, wherein a plurality of teeth are formed on the inner surface of each of the arms beside one or both sides of the respective receiving groove.

25. The device for cracking hard objects according to claim 20, wherein the dampening means are comprised of elastic material.

26. The device for cracking hard objects according to claim 25, wherein the dampening means are comprised of rubber or silicone.

27. The device for cracking hard objects according to claim 20, wherein the pair of arms are pivotally connected to each other.

28. The device for cracking hard objects according to claim 20, wherein the pair of arms are integrated with each other at one end to form a single piece.

29. The device for cracking hard objects according to claim 19, wherein
the base component is a frame with a screw hole formed through a top end thereof, and the actuating component is an actuating rod with a thread formed on outer surface thereof; and
through the screw hole, an upper end of the actuating rod extends outside of the frame with the thread of the actuating rod engaging with the thread in the screw hole.

30. The device for cracking hard objects according to claim 29, wherein the frame forms a closed configuration with an opening on a side thereof to access the hard objects to be cracked.

31. The device for cracking hard objects according to claim 29, wherein an inner surface of bottom of the frame is of a concave shape with a plurality of ribs radially formed thereon.

32. The device for cracking hard objects according to claim 29, wherein a surface of the jaw facing to the other one of the frame and the actuating rod is of a concave shape with a plurality of ribs radially formed thereon.

33. The device for cracking hard objects according to claim 29, wherein the dampening means are comprised of elastic material.

34. The device for cracking hard objects according to claim 33, wherein the dampening means are comprised of rubber or silicone.
